(19) United States
(12) Patent Application Publication
(10) Pub. No.: US 2012/0144364 A1
(43) Pub. Date: Jun. 7, 2012

(54) APPLICATION USER INTERFACE FOR NETWORKED-COMPUTING ENVIRONMENTS

(75) Inventors: Wilson W. Lau, San Francisco, CA (US); Srikanth Ramakrishna, Santa Clara, CA (US); Mohssen Alex Derafshan, Union City, CA (US)

(73) Assignee: INTUIT INC., Mountain View, CA (US)

(21) Appl. No.: 12/960,170

(22) Filed: Dec. 3, 2010

(51) Int. Cl. G06F 9/44; G06F 3/048

(52) U.S. Cl. 717/103

(57) ABSTRACT

A technique for using an application user interface that executes on a system is described. During operation of the system, a user specifies a design topology and configuration of an application that executes in a networked-computing environment through the application user interface. Then, the system provisions the application by bringing up associated hardware and/or software based on the design specified through the application user interface. Moreover, the application user interface monitors the application status during execution of the application so that application managers, application developers and application operators have access to the same information at different levels of an organizational hierarchy in the networked-computing environment.

### BACKGROUND

The present disclosure relates to tools for developing a software product. More specifically, the present disclosure relates to an application user interface that facilitates specification of an application that executes in a networked-computing environment, provisioning of the specified application, and monitoring of the application status during execution of the application.

Software products are increasingly being developed for networked-computing environments. For example, software products are often developed for a client-server architecture in a network (such as the Internet) and, more generally, a cloud-computing environment that facilitates web-based processing, in which shared resources and data are provided to computers and devices on demand.

However, in a cloud-computing environment the implementation details are often abstracted from the users, who often do not have the expertise in, or the control of, the technology infrastructure that supports a given software product. For example, in a cloud-computing environment the resources and infrastructure associated with a software product (such as the hardware and/or the software) can be provisioned dynamically and in a scalable fashion.

While this abstraction of the underlying resources provided by cloud-computing environments offers advantages, such as the ability to create applications with a customized user experience, it also can pose challenges. In particular, this abstraction makes the cloud-computing environment opaque to individuals with different functions in an organization or a company (such as application designers, application operators and managers). As a consequence, a comprehensive view of the ‘cloud environment,’ what is happening in it, or how to use it efficiently is often lacking.

To address this challenge, individuals often use disparate monitoring tools to collect subsets of the relevant information in the design and fulfillment process to assess the performance of a given software product. However, by its very nature, this approach is fragmented (if not incomplete); and prone to miscommunication (or a lack of communication) between the individuals, and, thus, also prone to errors. Collectively, these problems give rise to problems with the software product (for example, it may be difficult to anticipate problems during design or operation of a software product), with a commensurately adverse impact on reliability, customer satisfaction and sales.

### SUMMARY

The disclosed embodiments relate to a system that executes an application user interface. During operation, a user of the application user interface specifies a design topology and also a configuration of an application that executes in a networked-computing environment (such as cloud-computing or a data-center environment). Then, the system provisions the application by bringing up associated hardware and software based on the design specified through the application user interface. The application user interface also monitors the application status during execution of the application so that application managers, application developers (or application architects) and application operators have access to the same information at different levels of an organizational hierarchy in the networked-computing environment.

The above-described application user interface may include a rich-Internet application that supports drag-and-drop functionality when specifying the design topology and configuration. For example, the design topology and configuration may be specified using inter-connectable components that can be ‘plugged’ together or assembled via the application user interface. Moreover, the hardware (such as a database and/or a computer system) and the software (such as an operating system that executes on the computer system and a configuration of the computer system) may include components that are treated as generic components by the application user interface.

Furthermore, the information may include run-time information about the operation of the application in the networked-computing environment.

In some embodiments, the provisioning of the application is performed by a provisioning engine or a policy engine.

Additionally, the application user interface may receive user-provided configuration parameters for the hardware and/or the software.

In some embodiments, the application user interface allows a developer to modify an existing application to create the application (e.g., another instance or a modified version of the existing application), thereby using the existing application as the template for the application.

Another embodiment provides a method that includes at least some of the operations performed by the computer system.

Another embodiment provides a computer-program product for use with the system. This computer-program product includes instructions for at least some of the operations performed by the system.

### BRIEF DESCRIPTION OF THE FIGURES

FIG. 1 is a flow chart illustrating a method for using an application user interface in accordance with an embodiment of the present disclosure.

FIG. 2 is a flow chart illustrating the method of FIG. 1 in accordance with an embodiment of the present disclosure.

FIG. 3 is a block diagram illustrating an application user interface in accordance with an embodiment of the present disclosure.

FIG. 4 is a block diagram illustrating a system that performs the method of FIGS. 1 and 2 in accordance with an embodiment of the present disclosure.

FIG. 5 is a block diagram illustrating a computer system that performs the method of FIGS. 1 and 2 in accordance with an embodiment of the present disclosure.

FIG. 6 is a block diagram illustrating a data structure for use in the computer system of FIG. 5 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a system, a technique for using an application user interface, and a computer-program product (e.g., software) for use with the system are described. During operation of the system, a user specifies a design topology and configuration of an application that executes in a networked-computing environment through the application user interface. Then, the system provisions the application by bringing up associated hardware and/or software based on the design specified through the application user interface. Moreover, the application user interface monitors the application status during execution of the application so that application managers, application developers and application operators have access to the same information at different levels of an organizational hierarchy in the networked-computing environment.

In this way, the application user interface facilitates design, implementation and monitoring of the application in a seamless fashion by multiple individuals with different functional responsibilities in an organization (such as a company or a provider of the application). Furthermore, by integrating the information at different levels of the organizational hierarchy associated with operation of the application in the networked-computing environment, the application user interface facilitates improved: performance, reliability, and customer service, thereby enhancing the user experience, customer loyalty and the profitability and market share of the provider of the application.

In the discussion that follows, the user may include one of a variety of entities, such as: an individual (for example, an architect, a developer, an operator, a manager, a member of an operations/product-support team, etc.), an organization, a business and/or a government agency. Furthermore, a ‘business’ should be understood to include: for-profit corporations, non-profit corporations, organizations, groups of individuals, sole proprietorships, government agencies, partnerships, etc.

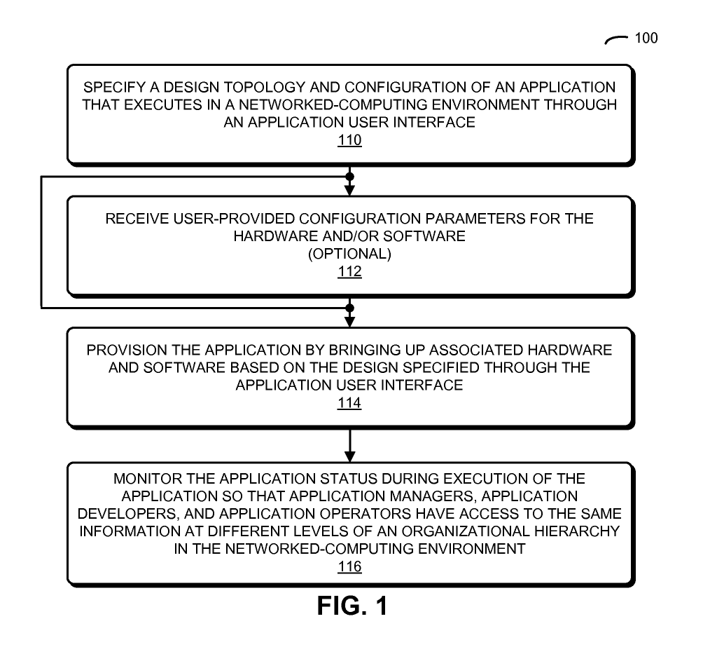

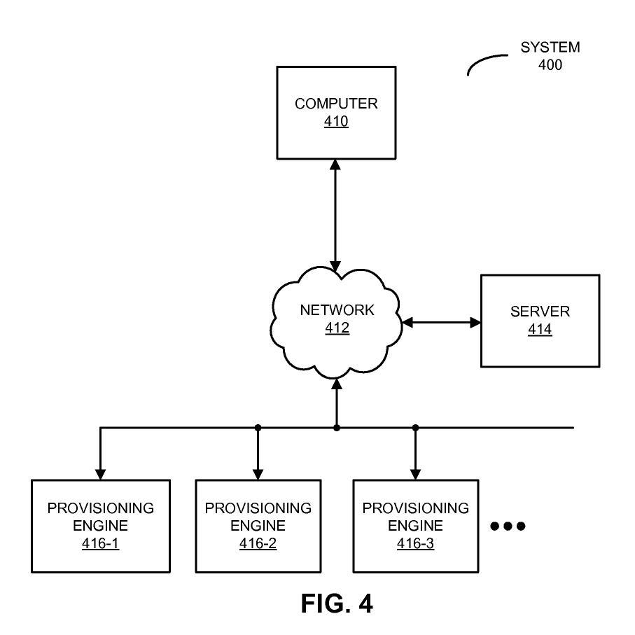

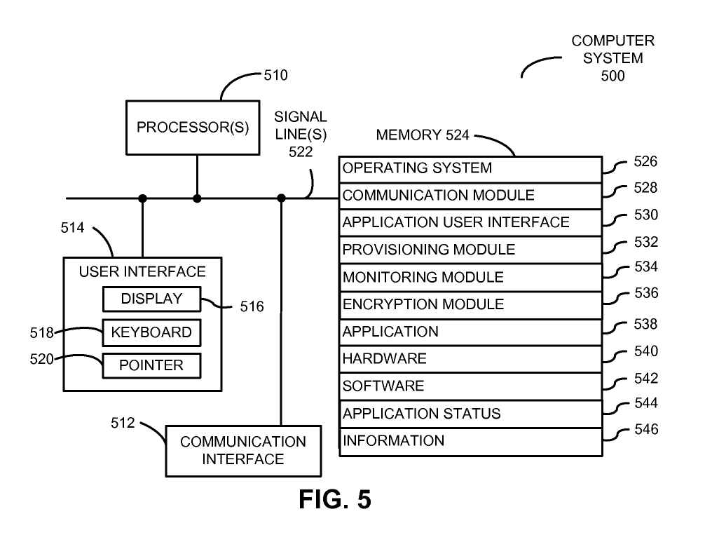

We now describe embodiments of a technique for using the application user interface. FIG. 1 presents a flow chart illustrating a method 100 for using an application user interface, which may be executed by a system (such as system 400 in FIG. 4) and/or a computer system (such as computer system 500 in FIG. 5). During operation, a user specifies a design topology and configuration of an application that executes in a networked-computing environment (operation 110), such as a cloud-computing and/or a data-center environment, through the application user interface.

Note that the application user interface may include a rich-Internet application that supports drag-and-drop functionality when specifying the design topology and configuration. For example, the design topology and configuration may be specified using inter-connectable components that can be ‘plugged’ together or assembled via the application user interface. Moreover, the hardware (such as a database and/or a computer system) and/or the software (such as an operating system that executes on the computer system and/or a configuration of the computer system) may include components that are treated as generic components by the application user interface (e.g., the components may be treated as ‘virtual’ components).

Then, the system provisions the application by bringing up associated hardware and software based on the design specified through the application user interface (operation 114). In some embodiments, provisioning the application is performed by a provisioning engine and/or a policy engine, such as software that executes at decision points to: perform policy selection; evaluate conditions; and determine what actions must be performed. In general, the functionality associated with a provisioning engine and/or a policy engine may be distributed through many parts of a system (such as system 400 in FIG. 4).

Moreover, the application user interface monitors the application status during execution of the application so that application managers, application developers (or application architects) and application operators have access to the same information at different levels of an organizational hierarchy in the networked-computing environment (operation 116). For example, the information may include run-time information about the operation of the application in the networked-computing environment.

In some embodiments, the application user interface optionally receives user-provided configuration parameters for the hardware and/or the software (operation 112).

Furthermore, in some embodiments the application user interface allows a developer to modify an existing application to create the application (e.g., another instance or a modified version of the existing application), thereby using the existing application as the template for the application.

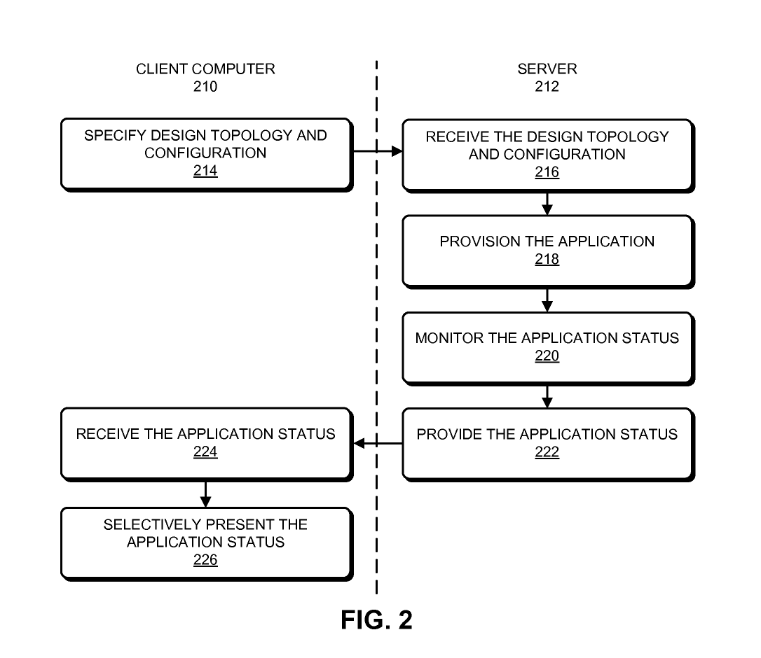

In an exemplary embodiment, the technique for using the application user interface is implemented using one or more client computers and at least one server computer, which communicate through a network, such as the Internet (i.e., using a client-server architecture). This is illustrated in FIG. 2, which presents a flow chart illustrating method 100. During this method, a user of a client computer 210 uses the application user interface to specify the design topology and configuration of the application that executes in the networked-computing environment (operation 214). In some embodiments, specifying the design topology and configuration of the application may involve receiving user-provided configuration parameters for the hardware and/or the software associated with the application.

After receiving the specified design topology and configuration from the application user interface (operation 216), server 212 provisions the application by bringing up associated hardware and software based on the specified design (operation 218). For example, server 212 may instruct a provisioning engine or a policy engine to provision the application.

Then, during execution of the application, the application user interface monitors the application status (operation 220), such as run-time information about the operation of the application in the networked-computing environment. The application status is provided to client computer 210 (operation 222). When the application status is received by client computer 210 (operation 224), it is selectively presented to application managers, application developers (or application architects) and application operators using the application user interface (operation 226), so that these individuals have access to the same information at different levels of an organizational hierarchy in the networked-computing environment. For example, the selective presentation may be based on specific information requests from these individuals.

In some embodiments of method 100 (FIGS. 1 and 2) there may be additional or fewer operations. Moreover, the order of the operations may be changed, and/or two or more operations may be combined into a single operation.

The application user interface can provide an end-to-end design, provisioning and monitoring tool, thereby allowing interaction from design to product deployment, including feedback from the operations/production-support team. Thus, the application user interface can provide support from design or conception to the systematic monitoring of relevant parameters during operation of the application.

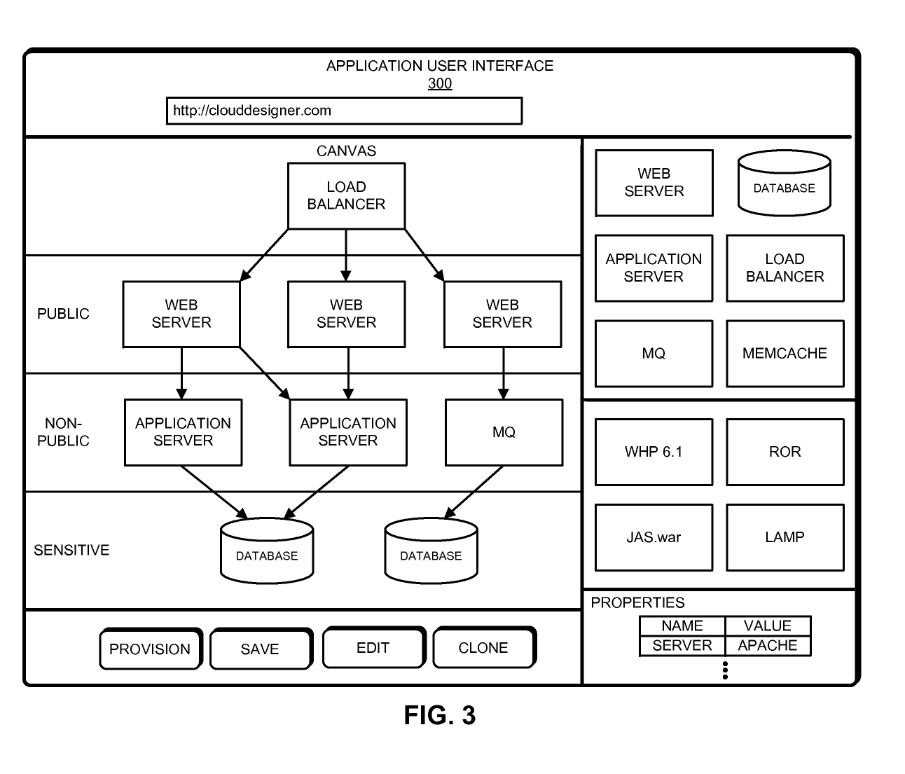

As shown below with reference to FIG. 3, the application user interface may be a what-you-see-is-what-you-get (WYSIWYG) web-based design editor that enables users to design the topology and configuration of the application that executes in the networked-computing environment. For example, using the application user interface, a user (such as a developer) can provide the configuration of the various components (including hardware, such as: a web server, an application server, a database server, a load balancer, etc; and software, such as: a web hosting pad, a ‘Ruby on Rails’ software developer, LAMP software, a custom application stack, etc.), as well as the various access control lists that are needed for the specified topology to work.

As shown in FIG. 3, during the design process, a user (such as a developer) can drag and drop the required resources into a canvas which occupies most of the real estate in the application user interface. While designing an application, the properties of the resources can be edited as well.

Once the topology and configuration are specified, the design can be saved for subsequent use. Note that, when a user saves (or provisions) a design, a dialog box may request a unique name for the design. Furthermore, when a design is saved for subsequent provisioning, the developer and operations/production-support team can communicate via the application user interface using a forum like plug-in, which allows interaction during the design process.

After saving the design, the user can request provisioning. This provisioning action may create the entire application configuration and topology in the networked-computing environment. Typically, when provisioning is requested, the design is validated and checked for any errors. In some embodiments, during validation a design is converted into a format that can be understood by vCenter™ Server Utilization Management (provided by VMware, Inc. of Palo Alto, Calif.), or into a more generic format such as the open virtualization format. Once the provisioning system sets up the servers and the associated hardware in the configuration, the topology can be updated with the status of systems and applications.

After verification, a ‘checked’ topology file may be sent to the back-end of the networked-computing environment (such as a cloud-platform) for provisioning. During provisioning, the various operations may be reported via the application user interface. In case the operations/production-support team has a question, this may be reported back, via the application user interface, so that the developer can respond to it. Note that if the provisioning involves opening a network port, a remedy ticket may need to be raised. In these embodiments, the application user interface may perform this operation.

Next, the operations/production-support team can see the provisioned topology, as well as the real-time status of the components in the application. This real-time status of most or all of the networked-computing environment may allow the operations/production-support team to address potential problems before a component in the application fails.

In particular, the status of the application may be obtained by integrating it with a variety of enterprise monitoring tools, such as: Spectrum Enterprise Manager (provided by CA Technologies of Islandia, N.Y.), eHealth Performance Manager (provided by CA Technologies of Islandia, N.Y.), Wily Technology (provided by CA Technologies of Islandia, N.Y.), etc. The data collected may include: administrative information (such as an axis control list, including: the status of application, the status of the network, the bandwidth, an ACL manager, etc.), operations/production-support information (including processor usage, a transaction log database, a table space for a database, etc.), and/or a management view of the overall performance.

In some embodiments, the data gathered by these tools is parsed and cached using an application such as memcache (a distributed memory object caching system) or a key-value store. Furthermore, the data may be fetched from the cache for display in the web-based application user interface. Note that the application user interface may use scripts to perform data migration.

In an exemplary embodiment, a developer/architect uses the application user interface as a tool to deploy an application in a development environment. In particular, the developer may use the application user interface to set up machines and deploy the application components with a specified configuration. This process may be repeated several times during the life cycle of any application. Using the application user interface, the developer can design a topology and provision the environment. This topology can also be saved as a template for subsequent use.

Once the development cycle has been vetted, the application deployment topology and configurations for this template can be shared with the operations/production-support team for production deployment.

Note that an ‘environment’ can also depend on other environments. For example, an authentication service may be created using the application user interface. Moreover, another environment may use this authentication service. Consequently, a dependency between the two environments may be created in the application user interface.

Typically, the operations/production-support team is in charge of production servers (developers, as such, do not handle the machines directly). Currently, communication between the developers and the operations/production-support team is typically through: topology diagrams, spreadsheets and emails. This disconnected and disjointed approach to communication is prone to error.

Using the application user interface, the developer can share what a production setup should look like. Then, the operations/production-support team can ask for clarification using the application user interface. Note that, typically, setting up a production environment may be spread over at least a couple of days. During this time, the developer can follow the progress of the provisioning process via the application user interface.

Furthermore, real-time status (such as one or more performance metrics, which may be associated with: a processor, a memory, a network connection, etc.) of the application can be monitored using the application user interface, which enables quick troubleshooting in a production environment.

Note that when an application is running in production, the management typically needs to know how the application is performing. For example, information such as how many virtual machines have been used at any given point in time may be needed. In addition, the environmental dependencies, such as routers, shared storage, etc., may need to be reported too. This information, as well as other statistics (such as a number of environments created by a business unit, etc.) can be monitored and displayed in the application user interface. Thus, a manager can determine the dependencies in the environment using the application user interface.

We now describe embodiments of the application user interface. FIG. 3 presents a block diagram illustrating an application user interface 300. This application user interface has features that allow it to be customized to enhance functionality. These features may act on the resources in the networked-computing environment, without manual secure-shell operations. Thus, application user interface 300 may support operations, such as: start, stop, restart etc., which may be performed using a single mouse click or user-interface operation.

As noted previously, application user interface 300 can be used as a developer or design tool to specify the configuration and topology of an application for use in a networked-computing environment. For example, a designer can drag and drop resources and interconnect them (such as the components on the right-hand side, which are then configured in the scratch pad or canvas on the left-hand side). In an exemplary embodiment, the application may include two machines with a particular topology and configuration. Note that these machines (or computers) may use different operating systems.

Subsequent provisioning may bring up the machines per the design specified using application user interface 300.

Then, application user interface 300 can be used to monitor operation of the application in real time (such as the status/health of the components in the application, as well as that of the overall networked-computing environment). This information may be concurrently presented (or made available) to developers, aggregators, managers, etc., so that they have a comprehensive view or perspective of what is happening in the networked-computing environment. These different individuals may select a subset of the information at different levels in the hierarchy of the networked-computing environment. However, because they all have access to the same information, their situational awareness is enhanced, thereby facilitating improved: communication, performance and reliability.

We now describe embodiments of the system and a computer system (which may be included in the system). FIG. 4 presents a block diagram illustrating a system 400 that performs method 100 (FIGS. 1 and 2). In this system, a user of computer 410 may use a software product that displays the application user interface. For example, the user may interact with a web page that is provided by server 414 via network 412, and which is rendered by a web browser on computer 410. Alternatively, the user may use a software application that is resident on and that executes on computer 410. This software application may be a stand-alone application or a portion of another application that is resident on and which executes on computer 410 (such as software that is provided by server 414 or that is installed and which executes on computer 410).

In some embodiments, at least a portion of the software application may be an application tool (such as a software application tool) that is embedded in the web page (and which executes in a virtual environment of the web browser). Thus, the software application tool may be provided to the user via a client-server architecture.

As discussed previously, the user may specify a design configuration and topology for an application (which is to be executed in a networked-computing environment, such as that shown in FIG. 4) using the application user interface. This design information may be received, via network 412, by server 414, and may be validated and/or stored.

Then, one or more of provisioning engines 416 may provision the application by bringing up associated hardware and/or software based on the specified design provided by the application user interface. For example, the design may be provided directly by the application user interface (e.g., from computer 410 via network 412) or from server 414 (via network 412).

Moreover, the application user interface may monitor the application status during operation of the application so that application managers, application developers (or application architects) and application operators have access to the same information at different levels of an organizational hierarchy in the networked-computing environment. This monitoring may be performed directly by the application user interface (e.g., at computer 410 via network 412) or by using monitoring tools that execute on server 414 (in which case the monitored information may be communicated from server 414 to computer 410, via network 412, for display by the application user interface).

Note that the design and the application status, as well as other information in system 400 may be stored at one or more locations in system 400 (i.e., locally or remotely). Moreover, because this data may be sensitive in nature, it may be encrypted. For example, stored data and/or data communicated via network 412 may be encrypted.

FIG. 5 presents a block diagram illustrating a computer system 500 that performs method 100 (FIGS. 1 and 2), such as server 414 (FIG. 4). Computer system 500 includes one or more processing units or processors 510, a communication interface 512, a user interface 514, and one or more signal lines 522 coupling these components together. Note that the one or more processors 510 may support parallel processing and/or multi-threaded operation, the communication interface 512 may have a persistent communication connection, and the one or more signal lines 522 may constitute a communication bus. Moreover, the user interface 514 may include: a display 516, a keyboard 518, and/or a pointer 520, such as a mouse.

Memory 524 in computer system 500 may include volatile memory and/or non-volatile memory. More specifically, memory 524 may include: ROM, RAM, EPROM, EEPROM, flash memory, one or more smartcards, one or more magnetic disc storage devices, and/or one or more optical storage devices. Memory 524 may store an operating system 526 that includes procedures (or a set of instructions) for handling various basic system services for performing hardware-dependent tasks. Memory 524 may also store procedures (or a set of instructions) in a communication module 528. These communication procedures may be used for communicating with one or more computers and/or servers, including computers and/or servers that are remotely located with respect to computer system 500.

Memory 524 may also include multiple program modules (or sets of instructions), including: application user interface 530 (or a set of instructions), provisioning module 532 (or a set of instructions), monitoring module 534 (or a set of instructions) and/or encryption module 536 (or a set of instructions). Note that one or more of these program modules (or sets of instructions) may constitute a computer-program mechanism.

During method 100 (FIG. 1), a user may use application user interface 530, which is displayed on display 516 (and, more generally, in user interface 514). (Note that display 516 may include a touch-sensitive display, a physical monitor and/or a virtual display in which information is projected onto another surface.) In particular, the user may specify a design topology and configuration of an application 538 that executes in a networked-computing environment. For example, application 538 may include financial software or a medical application (such as a diagnostic program, an electronic medical record program, a medical billing program, etc.).

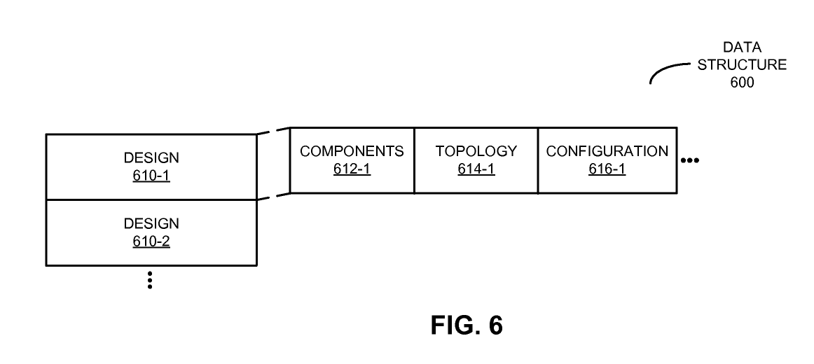

The resulting design may be stored in a data structure. This data structure is shown in FIG. 6, which presents a block diagram illustrating a data structure 600. In particular, data structure 600 may include designs 610. For example, design 610-1 may include: components 612-1 (including hardware and/or software), topology 614-1, and/or configuration 616-1 (which may include configuration parameters provided by the user).

Referring back to FIG. 5, provisioning module 532 may provision application 538 by bringing up associated hardware 540 and/or software 542 based on the specified design provided by the application user interface 530. Moreover, the application user interface 530 may monitor application status 544 during operation of application 538 so that application managers, application developers (or application architects) and application operators have access to the same information 546 at different levels of an organizational hierarchy in the networked-computing environment.

Furthermore, because application 538 and/or information 546 may be sensitive in nature, in some embodiments at least some of the data stored in memory 524 and/or at least some of the data communicated using communication module 528 is encrypted using encryption module 536.

Instructions in the various modules in memory 524 may be implemented in: a high-level procedural language, an object-oriented programming language, and/or an assembly or machine language. Note that the programming language may be compiled or interpreted, e.g., configurable or configured, to be executed by the one or more processors 510.

Although computer system 500 is illustrated as having a number of discrete items, FIG. 5 is intended to be a functional description of the various features that may be present in computer system 500 rather than a structural schematic of the embodiments described herein. In practice, and as recognized by those of ordinary skill in the art, the functions of computer system 500 may be distributed over a large number of servers or computers, with various groups of the servers or computers performing particular subsets of the functions. In some embodiments, some or all of the functionality of computer system 500 may be implemented in one or more application-specific integrated circuits (ASICs) and/or one or more digital signal processors (DSPs).

Computers and servers in system 400 (FIG. 4) and/or computer system 500 may include one of a variety of devices capable of manipulating computer-readable data or communicating such data between two or more computing systems over a network, including: a personal computer, a laptop computer, a mainframe computer, a portable electronic device (such as a cellular phone or PDA), a server and/or a client computer (in a client-server architecture). Moreover, network 412 (FIG. 4) may include: the Internet, World Wide Web, an intranet, LAN, WAN, MAN, or a combination of networks, or other technology enabling communication between computing systems.

In exemplary embodiments, application 538 includes a financial-software application (e.g., financial software), such as: Quicken™ and/or TurboTax™ (from Intuit, Inc., of Mountain View, Calif.), Microsoft Money™ (from Microsoft Corporation, of Redmond, Wash.), SplashMoney™ (from SplashData, Inc., of Los Gatos, Calif.), Mvelopes™ (from In2M, Inc., of Draper, Utah), and/or open-source applications such as Gnucash™, PLCash™, Budget™ (from Snowmint Creative Solutions, LLC, of St. Paul, Minn.), and/or other planning software capable of processing financial information.

Moreover, the financial-software application may include software such as: QuickBooks™ (from Intuit, Inc., of Mountain View, Calif.), Peachtree™ (from The Sage Group PLC, of Newcastle Upon Tyne, the United Kingdom), Peachtree Complete™ (from The Sage Group PLC, of Newcastle Upon Tyne, the United Kingdom), MYOB Business Essentials™ (from MYOB US, Inc., of Rockaway, N.J.), NetSuite Small Business Accounting™ (from NetSuite, Inc., of San Mateo, Calif.), Cougar Mountain™ (from Cougar Mountain Software, of Boise, Id.), Microsoft Office Accounting™ (from Microsoft Corporation, of Redmond, Wash.), Simply Accounting™ (from The Sage Group PLC, of Newcastle Upon Tyne, the United Kingdom), CYMA IV Accounting™ (from CYMA Systems, Inc., of Tempe, Ariz.), DacEasy™ (from Sage Software SB, Inc., of Lawrenceville, Ga.), Microsoft Money™ (from Microsoft Corporation, of Redmond, Wash.), Tally.ERP (from Tally Solutions, Ltd., of Bangalore, India) and/or other payroll or accounting software capable of processing payroll information.

Application user interface 300 (FIG. 3), system 400 (FIG. 4), computer system 500 (FIG. 5) and/or data structure 600 may include fewer components or additional components. Moreover, two or more components may be combined into a single component, and/or a position of one or more components may be changed. In some embodiments, the functionality of system 400 (FIG. 4) and/or computer system 500 may be implemented more in hardware and less in software, or less in hardware and more in software, as is known in the art.

While the preceding discussion illustrated the use of the application user interface within an organization or a company in the context of a networked-computing environment, in some embodiments the application user interface may be a service that is provided to third parties or partners of the organization. Furthermore, in other embodiments this technique may be used to specify, provision and monitor an application that executes in a wide variety of environments in addition to networked-computing environments, such as those that contain information at different levels of an organizational hierarchy. In this way, multiple individuals with different functional responsibilities in an organization (such as a company and, more generally, a provider of the application) can have access to the same information. Moreover, the information may be updated dynamically in real time (or near real time), thereby improving the situational awareness of the individuals while the application is executing.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-implemented method for using an application user interface, comprising:
specifying a design topology and configuration of an application that executes in a networked-computing environment through the application user interface, which executes on a computer;
provisioning the application by bringing up associated hardware and software based on the design specified through the application user interface; and
monitoring the application status via the application user interface during execution of the application so that application managers, application developers and application operators have access to the same information at different levels of an organizational hierarchy in the networked-computing environment.

2. The method of claim 1, wherein the application user interface includes a rich-Internet application that supports drag-and-drop functionality when specifying the design topology and configuration.

3. The method of claim 1, wherein the hardware and the software include components that are treated as generic components by the application user interface.

4. The method of claim 1, wherein the hardware includes one or more of a database and a computer system.

5. The method of claim 4, wherein the software includes one or more of an operating system that executes on the computer system and a configuration of the computer system.

6. The method of claim 1, wherein the information includes run-time information about the operation of the application in the networked-computing environment.

7. The method of claim 1, wherein the provisioning of the application is performed by a provisioning engine or a policy engine.

8. The method of claim 1, wherein the application user interface is configured to receive user-provided configuration parameters for either or both of the hardware and the software.

9. The method of claim 1, wherein the application user interface allows a developer to modify an existing application to create the application, thereby using the existing application as the template for the application.

10. A non-transitory computer-program product for use in conjunction with a computer system, the computer-program product comprising a computer-readable storage medium and a computer-program mechanism embedded therein, to facilitate the use of an application user interface, the computer-program mechanism including:
instructions for specifying a design topology and configuration of an application that executes in a networked-computing environment through the application user interface;
instructions for provisioning the application by bringing up associated hardware and software based on the design specified through the application user interface; and
instructions for monitoring the application status via the application user interface during execution of the application so that application managers, application developers and application operators have access to the same information at different levels of an organizational hierarchy in the networked-computing environment.

11. The computer-program product of claim 10, wherein the application user interface includes a rich-Internet application that supports drag-and-drop functionality when specifying the design topology and configuration.

12. The computer-program product of claim 10, wherein the hardware and the software include components that are treated as generic components by the application user interface.

13. The computer-program product of claim 10, wherein the hardware includes one or more of a database and a computer system.

14. The computer-program product of claim 13, wherein the software includes one or more of an operating system that executes on the computer system and a configuration of the computer system.

15. The computer-program product of claim 10, wherein the information includes run-time information about the operation of the application in the networked-computing environment.

16. The computer-program product of claim 10, wherein the provisioning of the application is performed by a provisioning engine or policy engine.

17. The computer-program product of claim 10, wherein the application user interface is configured to receive user-provided configuration parameters for either or both of the hardware and the software.

18. The computer-program product of claim 10, wherein the application user interface allows a developer to modify an existing application to create the application, thereby using the existing application as the template for the application.

19. A computer system, comprising:
a processor;
memory; and
a program module, wherein the program module is stored in the memory and configurable to be executed by the processor to facilitate the use of an application user interface, the program module including:
instructions for specifying a design topology and configuration of an application that executes in a networked-computing environment through the application user interface;
instructions for provisioning the application by bringing up associated hardware and software based on the design specified through the application user interface; and
instructions for monitoring the application status via the application user interface during execution of the application so that application managers, application developers and application operators have access to the same information at different levels of an organizational hierarchy in the networked-computing environment.

20. The computer system of claim 19, wherein the application user interface allows a developer to modify an existing application to create the application, thereby using the existing application as the template for the application.
